(19) United States
(12) Patent Application Publication
(10) Pub. No.: US 2018/0162323 A1
(43) Pub. Date: Jun. 14, 2018

(54) FOGGING REMOVAL SYSTEM AND FOGGING REMOVAL METHOD USING THE SAME

(71) Applicant: ELECTRONICS AND TELECOMMUNICATIONS RESEARCH INSTITUTE, Daejeon (KR)

(72) Inventors: Chan-Hwa HONG, Daejeon (KR); Woo-Seok CHEONG, Daejeon (KR)

(21) Appl. No.: 15/629,557

(22) Filed: Jun. 21, 2017

(30) Foreign Application Priority Data
Dec. 8, 2016 (KR) 10-2016-0167021

(51) Int. Cl. B60S 1/02; H05B 1/02; H05B 3/86

(52) U.S. Cl. CPC B60S 1/026; H05B 1/0236; H05B 2203/031; H05B 2203/014; H05B 3/86

(57) ABSTRACT

Provided is a fogging removal system. The fogging removal system includes: a first substrate; a heating unit disposed on the first substrate; a second substrate disposed on the heating unit; a first electrode disposed on the second substrate; and a control unit electrically connected to the heating unit and the first electrode. The heating unit heats at least a portion of the second substrate, and the heating unit and the first electrode constitute a capacitor.

### CROSS-REFERENCE TO RELATED APPLICATIONS

This U.S. non-provisional patent application claims priority under 35 U.S.C. § 119 of Korean Patent Application No. 10-2016-0167021, filed on Dec. 8, 2016, the entire contents of which are hereby incorporated by reference.

### BACKGROUND

The present disclosure herein relates to a fogging removal system, and more particularly, to a fogging removal system for glass.

If a temperature difference outside a room is large, fogging may occur in a window. Fogging may occur if the air containing moisture reaches a dew point in contact with a relatively low temperature window. If fogging occurs on glass windows or goggles, it may be seen as opaque due to interference with the field of view. In particular, in the case of a vehicle, fogging interferes with the driver's vision so that this may be a factor that greatly affects safe driving.

When fogging occurs on a vehicle glass, a driver operates the air conditioner or opens a window to ventilate the room air to remove the fogging. However, such a method takes a long time to remove the fogging, and the driver drives the vehicle with an unclear vision until the fogging phenomenon is completely removed, so that the risk of a safety accident is very high.

### SUMMARY

Embodiments of the present inventive provide an automatic fogging removal system.

Embodiments of the present inventive also provide a fogging removal system for detecting a fogging occurrence and removing the fogging.

Embodiments of the present inventive also provide a fogging removal system applicable to a large-area glass.

According to exemplary embodiments, a fogging removal system may include: a first substrate; a heating unit disposed on the first substrate; a second substrate disposed on the heating unit; a first electrode disposed on the second substrate; and a control unit electrically connected to the heating unit and the first electrode, wherein the heating unit heats at least a portion of the second substrate, and wherein the heating unit and the first electrode constitute a capacitor.

In an embodiment, the heating unit may be disposed between the first substrate and the second substrate, and the first electrode may be disposed on one surface of the second substrate opposite to the heating unit.

In an embodiment, the first electrode may be disposed between the first substrate and the second substrate, and the heating unit may be disposed on one surface of the second substrate opposite to the first electrode.

In an embodiment, the heating unit may include a transparent electrode, and the transparent electrode may include a transparent conductive oxide, a metal nanowire, a conductive organic material, or a metal mesh.

In an embodiment, the first electrode may include a metal film, a metal paste, a metal nanowire, a conductive organic material, or a metal mesh.

In an embodiment, the first substrate may include a transparent substrate; the second substrate may include a transparent substrate; and the transparent substrate may include poly(ethylene terephthalate) (PET), polyether sulfone (PES), poly carbonate (PC), polyethylene naphthalate) (PEN), poly(methyl methacrylate) (PMMA), polyimide (PI), cyclic olefin copolymer (COC), or glass.

In an embodiment, the fogging removal system may further include a second electrode disposed on the second substrate as spaced apart from the first electrode, and the second electrode and the heating units constitute a capacitor.

According to exemplary embodiments, provided is a fogging removal method of a fogging removal system including a first substrate, a heating unit disposed on the first substrate, a second substrate disposed on the heating unit, a first electrode disposed on the second substrate, and, a control unit electrically connected to the heating unit and the first electrode. The method includes: detecting an occurrence of fogging on the second substrate; heating the heating unit by applying power to the heating unit; detecting a removal of the fogging on the second substrate; and cutting off the power applied to the heating unit.

In an embodiment of the inventive concept, the detecting of the occurrence of the fogging on the second substrate may include: detecting a capacitance value between the heating unit and the first electrode; and comparing a reference value set in the control unit with the capacitance value.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a plan view illustrating a fogging removal system according to embodiments of the inventive concept;

FIG. 2 is a cross-sectional view taken along a line A-A′ of FIG. 1;

FIG. 3 is a plan view illustrating a fogging removal system according to embodiments of the inventive concept;

FIG. 4 is a cross-sectional view taken along a line B-B′ of FIG. 3;

FIG. 5 is a flowchart illustrating a fogging removal system according to embodiments of the inventive concept;

FIG. 6A is a view illustrating a fogging removal system manufactured according to experimental examples of the inventive concept;

FIG. 6B is a cross-sectional view taken along a line B-B′ of FIG. 6A; and

FIGS. 7A to 7D are views illustrating the occurrence of fogging in experimental examples of the inventive concept.

### DETAILED DESCRIPTION

In order to fully understand the configuration and effects of the technical spirit of the inventive concept, preferred embodiments of the technical spirit of the inventive concept will be described with reference to the accompanying drawings. However, the technical spirit of the inventive concept is not limited to the embodiments set forth herein and may be implemented in various forms and various modifications may be applied thereto. Only, the technical spirit of the inventive concept is disclosed to the full through the description of the embodiments, and it is provided to those skilled in the art that the inventive concept belongs to inform the scope of the inventive concept completely. Those of ordinary skill in the art will understand that the concepts of the inventive concept may be practiced in any suitable environment.

The terms used in this specification are used only for explaining specific embodiments while not limiting the present invention. The terms of a singular form may include plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components.

In this specification, when a film (or layer) is referred to as being on another film (or layer) or substrate, it may be directly on the other film (or layer) or substrate, or a third film (or layer) may be interposed.

It will be understood that the terms “first”, “second”, and “third” are used herein to describe various regions, films (or layers), and so on, but these regions, films (or layers), and so on should not be limited by these terms. These terms are only used to distinguish any predetermined region or film (or layer) from another region or film (or layer). Thus, a membrane referred to as a first membrane in one embodiment may be referred to as a second membrane in another embodiment. Embodiments described herein include complementary embodiments thereof. Like reference numerals refer to like elements throughout the specification.

Unless otherwise the terms used in embodiments of the inventive concept are defined differently, they may be interpreted as commonly known to those skilled in the art.

Hereinafter, a fogging removal system according to the concept of the inventive concept will be described with reference to the drawings.

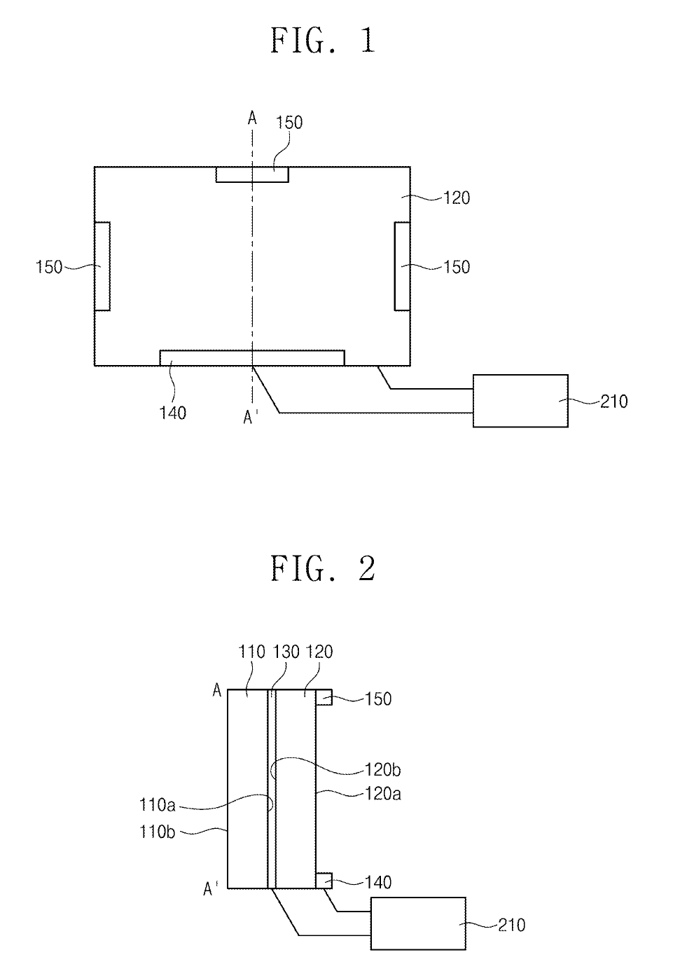

FIG. 1 is a plan view illustrating a fogging removal system according to embodiments of the inventive concept. FIG. 2 is a cross-sectional view taken along a line A-A′ of FIG. 1.

Referring to FIGS. 1 and 2, a first substrate 110 and a second substrate 120 may be provided. The first substrate 110 may have a first surface 110a and a second surface 110b opposite to each other. The second substrate 120 may have a third surface 120a and a fourth surface 120b opposite to each other. The first substrate 110 and the second substrate 120 may face each other. For example, the first surface 110a of the first substrate 110 and the fourth surface 120b of the second substrate 120 may face each other. The first substrate 110 and the second substrate 120 may include a transparent substrate. For example, the transparent substrate may include poly(ethylene terephthalate) (PET), polyether sulfone (PES), poly carbonate (PC), poly(ethylene naphthalate) (PEN), poly(methyl methacrylate) (PMMA), polyimide (PI), cyclic olefin copolymer (COC), or glass.

A heating unit 130 may be provided between the first substrate 110 and the second substrate 120. The heating unit 130 may cover the entire surfaces of the first surface 110a of the first substrate 110 and the fourth surface 120b of the second substrate 120. The heating unit 130 may include a transparent electrode. The transparent electrode may include a transparent conducting oxide (TCO), a metal nano-wire, or a metal mesh. The heating unit 130 may heat at least a portion of the first substrate 110 and the second substrate 120. For example, the heating unit 130 may receive electric power from a control unit 210 described later, and generate heat by the electric resistance. In embodiments, the heating unit 130 may have a thickness from 1 nanometer (nm) to 1 millimeter (mm). Here, the thickness of the heating unit 130 means the distance between both surfaces of the heating unit 130 in contact with the first substrate 110 and the second substrate 120.

A first electrode 140 may be disposed on the third surface 120a of the second substrate 120. At this time, the first electrode 140 may cover a portion of the third surface 120a of the second substrate 120 and may expose another portion of the third surface 120a of the second substrate 120. The first electrode 140 may include a metal film, a metal paste, a metal nanowire or a metal mesh. Alternatively, the first electrode 140 may include a transparent electrode. The first electrode 140 and the heating unit 130 may constitute a capacitor for storing electric charges therebetween.

In embodiments, if the fogging removal system requires high visibility, the first electrode 140 may be disposed on the outer portion of the third surface 120a of the second substrate 120. That is, the first electrode 140 may expose the center portion of the third surface 120a of the second substrate 120. However, the inventive concept is not limited thereto, and the first electrode 140 may be disposed at various positions on the third surface 120a of the second substrate 120, or may have various shapes.

The control unit 210 may be provided. The control unit 210 may be electrically connected to the heating unit 130 and the first electrode 140. The control unit 210 may supply power to the heating unit 130 for generating heat. The control unit 210 may measure a capacitance value between the heating unit 130 and the first electrode 140.

According to embodiments of the inventive concept, the fogging removal system may further include at least one second electrode 150. The second electrode 150 may be disposed on the third surface 120a of the second substrate 120 and may be spaced apart from the first electrode 140. At this time, the second electrode 150 may cover a portion of the third surface 120a of the second substrate 120 and may expose another portion of the third surface 120a of the second substrate 120. The second electrode 150 may include a metal film, a metal paste, a metal nanowire, a conductive organic material, or a metal mesh. Alternatively, the second electrode 150 may include a transparent electrode. The second electrode 150 and the heating unit 130 may constitute a capacitor for storing electric charges therebetween.

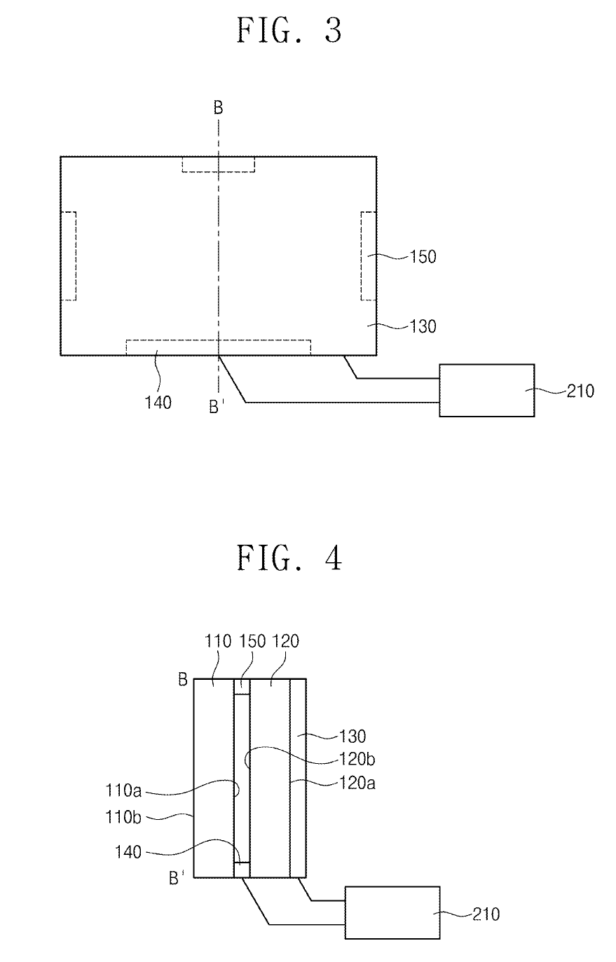

According to embodiments of the inventive concept, the heating unit 130 and the first electrode 140 may be disposed at various positions. FIG. 3 is a plan view illustrating a fogging removal system according to embodiments of the inventive concept. FIG. 4 is a cross-sectional view taken along a line B-B′ of FIG. 3.

Referring to FIGS. 3 and 4, the heating unit 130 may be disposed on the third surface 120a of the second substrate 120. The heating unit 130 may cover the entire surface of the third surface 120a of the second substrate 120.

The first electrode 140 may be provided between the first substrate 110 and the second substrate 120. At this time, the first electrode 140 may cover portions of the first surface 110a of the first substrate 110 and the fourth surface 120b of the second substrate 120 and expose other portions of the first electrode 110 of the first substrate 110 and the fourth surface 120b of the second substrate 120. The first electrode 140 and the heating unit 130 may constitute a capacitor for storing electric charges therebetween.

When the fogging removal system further includes the second electrode 150, the second electrode 150 may be provided between the first substrate 110 and the second substrate 120 and may be spaced apart from the first electrode 140. At this time, the second electrode 150 may cover portions of the first surface 110a of the first substrate 110 and the fourth surface 120b of the second substrate 120 and expose other portions of the first electrode 110 of the first substrate 110 and the fourth surface 120b of the second substrate 120. The second electrode 150 and the heating unit 130 may constitute a capacitor for storing electric charges therebetween.

According to embodiments of the inventive concept, when fogging occurs, the fogging removal system may automatically remove the fogging. Hereinafter, an operation method of the fogging removal system will be described.

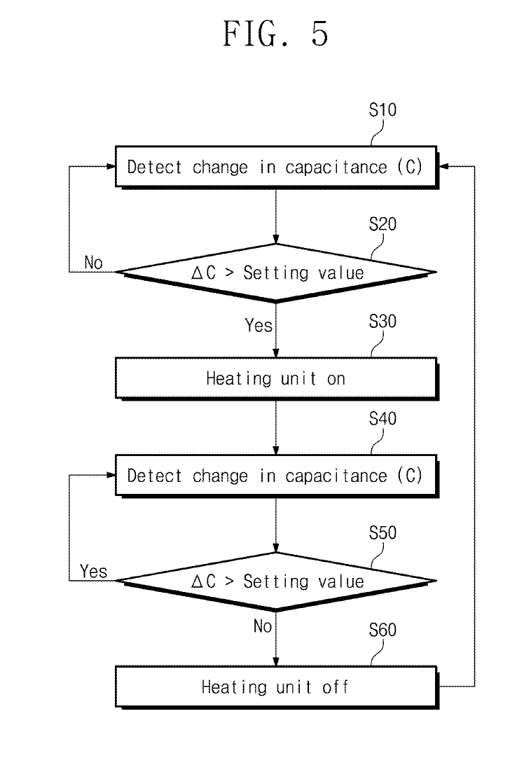

FIG. 5 is a flowchart illustrating a fogging removal system according to embodiments of the inventive concept.

Referring to FIGS. 1 to 5, a change in a capacitance value C between the heating unit 130 and the first electrode 140 may be detected (S10). For example, when fogging occurs on the third surface 120a of the second substrate 120, the capacitance value C between the heating unit 130 and the first electrode 140 may change. At this time, as the amount of fogging on the second substrate 120 is greater, a change in the capacitance value C between the heating unit 130 and the first electrode 140 is greater. The control unit 210 may detect a change in the capacitance value C between the heating unit 130 and the first electrode 140. For example, when a small size of voltage (for example, several mV) is applied to the heating unit 130 and the first electrode 140, the control unit 210 may extract the capacitance value C between the heating unit 130 and the first electrode 140 using a self-capacitance method or a multi capacitance method.

When the fogging removal system further includes the second electrode 150 according to embodiments, the control unit 210 may detect a change in the capacitance value C between the heating unit 130 and the second electrode 150. Accordingly, the control unit 210 may detect a change in the capacitance value C with a higher sensitivity according to a position where fogging occurs.

After the control unit 210 detects the occurrence of fogging, the control unit 210 may control the heating unit 130 (S20). For example, when fogging occurs, a change amount AC of a capacitance value detected by the control unit 210 may be greater than a reference value set in the control unit 210. At this time, the control unit 210 may apply power to the heating unit 130. For example, when fogging does not occur, a change amount AC of a capacitance value detected by the control unit 210 may be less than a reference value set in the control unit 210. At this time, the control unit 210 may not apply power to the heating unit 130.

The heating unit 130 may receive power from the control unit 210 to remove the fogging (S30). For example, if fogging occurs, the control unit 210 may heat the second substrate 120. As the temperature of the second substrate 120 increases, moisture on the second substrate 120 may evaporate.

A change in the capacitance value C between the heating unit 130 and the first electrode 140 may be detected (S40). For example, when the fogging on the second substrate 120 is removed, the capacitance value C between the heating unit 130 and the first electrode 140 may change. The control unit 210 may detect a change in the capacitance value C.

After the control unit 210 detects whether the fogging is removed, the control unit 210 may control the heating unit 130 (S50). For example, when the fogging is removed, a change amount AC of a capacitance value detected by the control unit 210 may be less than a reference value set in the control unit 210. At this time, the control unit 210 may cut off power supplied to the heating unit 130. For example, when the fogging is not removed, a change amount AC of a capacitance value detected by the control unit 210 may be greater than a reference value set in the control unit 210. At this time, the control unit 210 may not cut off power supplied to the heating unit 130.

The operation of the heating unit 130 may be stopped (S60). For example, if fogging is removed, the heating unit 130 may be powered off by the control unit 210. Thereafter, the fogging removal system may repeat the above operations (S10 to S60).

The fogging removal system according to embodiments of the inventive concept may include the heating unit 130 and the first electrode 140 for detecting the occurrence of fogging, and may remove fogging by using the heating unit 130. Accordingly, the fogging removal system may simultaneously detect the occurrence of fogging and remove the fogging. In addition, the fogging removal system may automatically remove the fogging by comparing a reference value set in the control unit 210 and a change in capacitance value between the heating unit 130 and the first electrode 140.

The heating unit 130 may cover the entire surface of the first substrate 110 and the second substrate 120. Therefore, the heating unit 130 may heat the entire surface of the first substrate 110 and the second substrate 120. Accordingly, it is applicable to a large-area glass.

### EXPERIMENTAL EXAMPLE

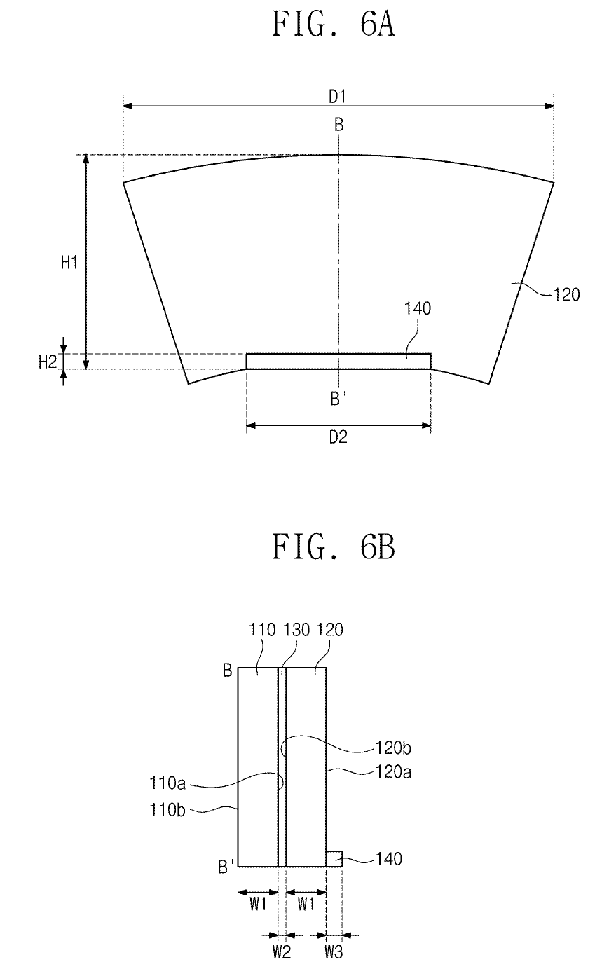

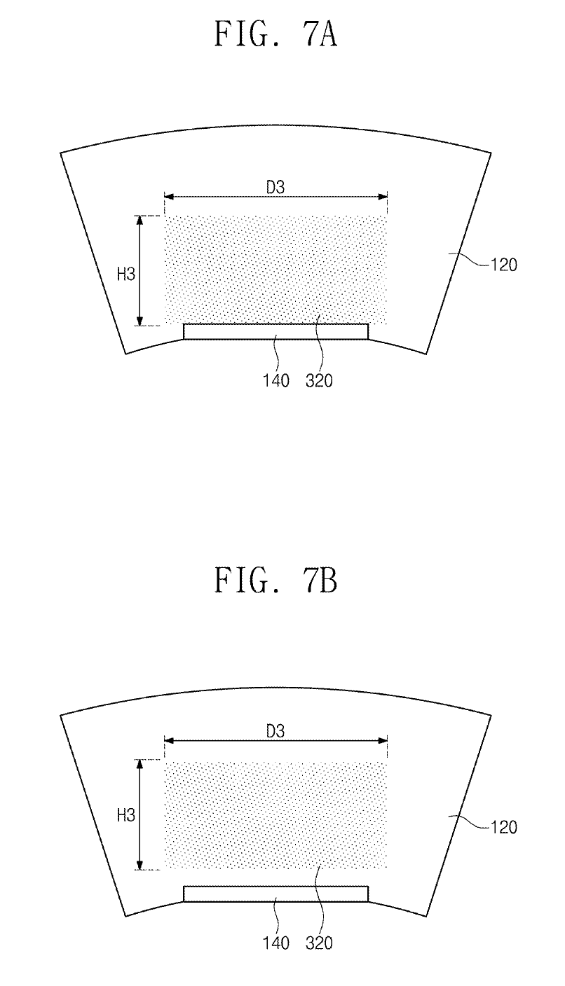

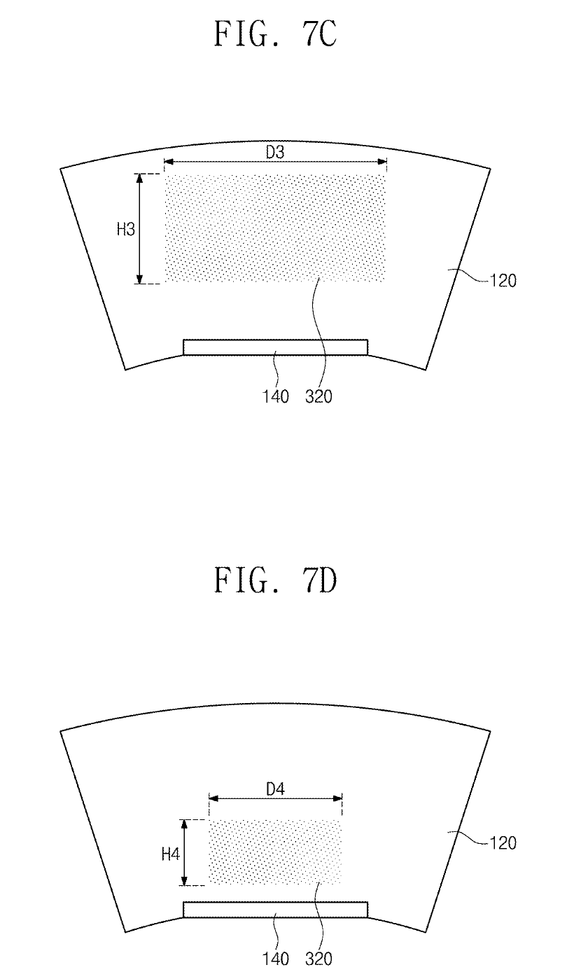

Experimental examples compared the amount of change in detected capacitance value while changing the position and amount of fogging occurring in the second substrate 120. FIG. 6A is a view illustrating a fogging removal system manufactured according to experimental examples of the inventive concept. FIG. 6B is a cross-sectional view taken along a line B-B′ of FIG. 6A. FIGS. 7A to 7D are views illustrating the occurrence of fogging in experimental examples of the inventive concept.

Referring to FIGS. 6A and 6B, a fogging removal system for vehicle was manufactured. Specifically, the first substrate 110 and the second substrate 120 were manufactured using a vehicle glass having a width D1 of 2000 mm, a height H1 of 1000 mm, and a thickness W1 of 1 mm. The heating unit 130 was manufactured using an indium tin oxide (ITO) electrode having a thickness W2 of 1 um. The first electrode 140 was manufactured using a copper electrode having a width D2 of 900 mm, a height H2 of 100 mm, and a thickness W3 of 30 mm. Here, the first electrode 140 was provided on the lower end one side of the second substrate 120. When no fogging occurred in the fogging removal system, a capacitance value between the heating unit 130 and the first electrode 140 was measured to be 352.71 pF.

Fogging was generated at different positions on the fogging removal system manufactured as described above, and a capacitance value change between the heating unit 130 and the first electrode 140 was measured.

Referring to FIGS. 7A to 7C, a fogging 320 having a width D3 of 1000 mm, a height H3 of 450 mm, and a thickness of 0.5 mm was formed on the second substrate 120.

As shown in 7A, when the fogging 320 was formed adjacent to the first electrode 140, a capacitance value between the heating unit 130 and the first electrode 140 was measured to be 184.84 pF. That is, a capacitance value between the heating unit 130 and the first electrode 140 showed a change of 47.6% compared to when the fogging 320 was formed.

As shown in 7B, when the fogging 320 was formed at the center of the second substrate 120, a capacitance value between the heating unit 130 and the first electrode 140 was measured to be 265.72 pF. That is, a capacitance value between the heating unit 130 and the first electrode 140 showed a change of 24.6% compared to when the fogging 320 was formed.

As shown in 7C, when the fogging 320 was formed fax away from the first electrode 140, a capacitance value between the heating unit 130 and the first electrode 140 was measured to be 271.94 pF. That is, a capacitance value between the heating unit 130 and the first electrode 140 showed a change of 22.9% compared to when the fogging 320 was formed.

Referring to FIG. 7D, a fogging 320 having a width D4 of 500 mm, a height H4 of 200 mm, and a thickness of 0.5 mm was formed on the second substrate 120. As shown in 7B, when a small amount of the fogging 320 was formed locally, a capacitance value between the heating unit 130 and the first electrode 140 was measured to be 261.49 pF. That is, a capacitance value between the heating unit 130 and the first electrode 140 showed a change of 25.8% compared to when the fogging 320 was formed.

As described above, the fogging removal system showed a high capacitance variation of 20% or more regardless of the occurrence position of the fogging. The fogging removal system may easily detect the occurrence of fogging.

A fogging elimination system according to embodiments of the inventive concept may include electrodes for detecting the occurrence of fogging. The fogging removal system may remove fogging by using one electrode of them. Accordingly, the fogging removal system may simultaneously detect the occurrence of fogging and remove the fogging. In addition, the fogging removal system may automatically remove the fogging by comparing a reference value set in a control unit and a change in capacitance value.

In addition, the heating unit of the fogging removal system may heat the entire surface of a substrate. Accordingly, application to large-area glass is advantageous.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A fogging removal system comprising:
a first substrate;
a heating unit disposed on the first substrate;
a second substrate disposed on the heating unit;
a first electrode disposed on the second substrate; and
a control unit electrically connected to the heating unit and the first electrode,
wherein the heating unit heats at least a portion of the second substrate, and
wherein the heating unit and the first electrode constitute a capacitor.

2. The fogging removal system of claim 1, wherein the heating unit is disposed between the first substrate and the second substrate, and the first electrode is disposed on one surface of the second substrate opposite to the heating unit.

3. The fogging removal system of claim 1, wherein the first electrode is disposed between the first substrate and the second substrate, and the heating unit is disposed on one surface of the second substrate opposite to the first electrode.

4. The fogging removal system of claim 1, wherein the heating unit comprises a transparent electrode, and the transparent electrode comprises a transparent conductive oxide, a metal nano wire, a conductive organic material, or a metal mesh.

5. The fogging removal system of claim 1, wherein the first electrode comprises a metal film, a metal paste, a metal nanowire, a conductive organic material, or a metal mesh.

6. The fogging removal system of claim 1, wherein:
the first substrate comprises a transparent substrate;
the second substrate comprises a transparent substrate; and
the transparent substrate comprises poly(ethylene terephthalate) (PET), polyether sulfone (PES), poly carbonate (PC), poly(ethylene naphthalate) (PEN), poly(methyl methacrylate) (PMMA), polyimide (PI), cyclic olefin copolymer (COC), or glass.

7. The fogging removal system of claim 1, further comprising a second electrode disposed on the second substrate as spaced apart from the first electrode, and the second electrode and the heating unit constitute a capacitor.

8. A fogging removal method of a fogging removal system including a first substrate, a heating unit disposed on the first substrate, a second substrate disposed on the heating unit, a first electrode disposed on the second substrate, and, a control unit electrically connected to the heating unit and the first electrode, the method comprising:
detecting an occurrence of fogging on the second substrate;
heating the heating unit by applying power to the heating unit;
detecting a removal of the fogging on the second substrate; and
cutting off the power applied to the heating unit.

9. The method of claim 8, wherein the detecting of the occurrence of the fogging on the second substrate comprises:
detecting a capacitance value between the heating unit and the first electrode; and
comparing a reference value set in the control unit with the capacitance value.
